(19) United States
(12) Patent Application Publication
(10) Pub. No.: US 2009/0024717 A1
(43) Pub. Date: Jan. 22, 2009

(54) Media file reproducing system and method thereof

(76) Inventor: Hyo-Jun Im, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 10/587,815

(22) PCT Filed: Sep. 16, 2004
(86) PCT No.: PCT/KR04/02365

§ 371 Date: Jul. 27, 2006

(30) Foreign Application Priority Data
Jan. 30, 2004 (KR) 10-2004-0006330

(51) Int. Cl. G06F 15/173

(52) U.S. Cl. 709/218

(57) ABSTRACT

Disclosed are a media file reproducing system and a method thereof capable of easily reproducing a media file inside a file server that does not provide a UPnP content directory service (CDS) through a UPnP media renderer connected to a UPnP-based network. The media file reproducing method comprises: receiving position information of a filer server that provides a file transfer protocol service and a distributed file service through a media server connected to the UPnP-based network; and reproducing the media filed inside the file server through the media renderer connected to the UPnP-based network based on the position information.

### TECHNICAL FIELD

The present invention relates to a UPnP(Universal Plug and Play)-based network system, and more particularly to, a system and method of playing back media files via a UPnP-based network.

### BACKGROUND ART

Recently, with the distribution of very high speed internet and the digitalization of home electric appliances, there is being made an attempt to configure PCs (personal computers), network gateway apparatuses, audio/video devices, home electronic equipment, control devices, etc. at home as a single home network.

Currently, as a PC-based network environment has been changing more and more into an environment employing a variety of subnetwork techniques with the spread of home networking, there has been suggested- Universal Plug and Play (UPnP) technology with the need for a technique capable of networking home electric appliances in an independent and unified way using an IP protocol.

The aforementioned UPnP is defined by the protocol of a standard network architecture, which is one of the leading standard techniques for home networks being made by establishing a UPnP forum between a number of companies of in countries around the world. The above UPnP-based home network system is comprised of multiple UPnP devices providing services and a control point (CP) controlling the multiple UPnP devices.

The control point (CP) denotes a controller having the function of sensing and controlling a variety of devices. That is, the control point (CP), as the controller controlling a variety of devices (for example, UPnP devices), discovers various kinds of UPnP devices, finds out the descriptions of the discovered UPnP devices and controls the UPnP devices according to a user's key input.

The UPnP devices include PCs (personal computers), network equipment, peripheral devices, such as a printer, audio/video devices, home electric equipment, etc. which are all connected to a home network. They inform the control point of their event.

The current UPnP-based home network system controlling audio/video devices comprises: a UPnP media server providing media contents (e.g., media files) via a home network; a UPnP media renderer playing media contents provided via the home network; and a UPnP control point controlling the UPnP media server and the UPnP media renderer.

The UPnP control point is informed of the status information of the UPnP media server and of the UPnP media renderer through an event. For instance, when the UPnP media server and the UPnP media renderer provide AV(audio/video) transport service and rendering control service, a changed state variable is put into a state variable table named ‘Last Change’ and the UPnP control point is informed of the changed state variable, to thus enable the UPnP control point to know the current state of a corresponding UPnP device.

The UPnP media server informs the UPnP control point of the information on the media contents whenever an UPnP action occurs.

Further, the UPnP media server transmits the corresponding media contents to the UPnP media renderer by a streaming method in order to play the media contents. At this time, although the above streaming method can be any of various methods suggested, the current UPnP Audio/Video V standard uses ‘Out-of-Band transfer protocol’ for streaming.

Afterwards, the UPnP media renderer plays the media contents (media files) transmitted from the UPnP media server. Conventionally, however, there have been suggested no method in which a file server, which does not provide any UPnP CDS (Content Directory Service) for providing a list of media files and the information on the media files, can service its media files through the UPnP media renderer. Thus the media files in the files server cannot be played through the UPnP media renderer.

### DISCLOSURE OF THE INVENTION

Therefore, an object of the present invention is to provide media file reproducing (playback) system and method which is able to easily play back media files in a file server not providing any UPnP CDS (Content Directory Service) through a UPnP media renderer connected to a UPnP-based network.

To achieve the above object, there is provided a media file playback method in accordance with the present invention, comprising the steps of: receiving position information of a file server providing a FTP (file transfer protocol) service and/or a distributed file service through a media server connected to a UPnP(Universal Plug and Play)-based network; and playing back a medial file in the file server through a media renderer connected to the UPnP-based network based on the position information.

To achieve the above object, there is provided a media file playback method in accordance with the present invention, comprising the steps of: receiving position information of a file server providing a FTP (file transfer protocol) service and/or a distributed file service through a media server connected to a UPnP(Universal Plug and Play)-based network; downloading a media file in the file server by accessing to the file server based on the position information; and playing back the downloaded media file through a media renderer connected to the UPnP-based network.

To achieve the above object, there is provided a media file playback method in accordance with the present invention, comprising the steps of: receiving position information of a FTP (file transfer protocol) server or a distributed file server through a media server providing media contents via a UPNP-based network; acquiring a media file list in the file server based on the position information; providing the acquired media file list to a control point connected to the UPnP-based network through the media server; providing the address information of a media file selected by a user from the acquired media file list to a media renderer connected to the UPNP-based network under control of the control point; downloading the media file corresponding to the address information of the medial file selected by the user directly from the file server through the media renderer; and playing back the downloaded media file through the media renderer.

To achieve the above object, there is provided a media file playback system in accordance with the present invention, comprising: a file server being connected to a network and providing a media file; a media server being connected to the network and the UPnP-based network and receiving a media file list in the file server via the network based on the position information of the file server; a media renderer being connected to the network and the UPnP-based network and playing back the media file corresponding to at least one media file address registered in the media file list of the file server.

To achieve the above object, there is provided a media file playback system in accordance with the present invention, comprising: a file server providing a FTP(file transfer protocol) service and/or a distributed file service so as to transmit first medial files via a network; a UPnP media server being to the above network and a UPnP-based network, providing a CDS (content directory service) transmitting the information of second medial files and acquiring a first media file list having the address information of the first media files; a UPnP control point being connected to the UPnP-based network, acquiring the first media file list from the media server by requesting the media server for a the first media file list and providing the address of a medial file selected by a user from the acquired first media file list; and a UPnP media renderer being connected to the UPnP-based network, downloading the media file corresponding to the above media file address directly from the file server and playing back the downloaded media file.

To achieve the above object, there is provided a media file playback system in accordance with the present invention, comprising: a FTP (file transfer protocol) server; and a media renderer being connected to a UPnP-based network, downloading a medial file provided from the FTP server based on the position information of the FTP server and playing back the downloaded media file.

To achieve the above object, there is provided a media file playback system in accordance with the present invention, comprising: a distributed file server; and a media renderer being connected to a UPnP-based network, downloading a medial file provided from the distributed file server based on the position information of the distributed file server and playing back the downloaded media file.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing a media file playback system in accordance with the present invention; and

FIG. 2 is a signal flow chart showing a media file playback method in accordance with the embodiment of the present invention.

### MODES FOR CARRYING OUT THE PREFERRED EMBODIMENTS

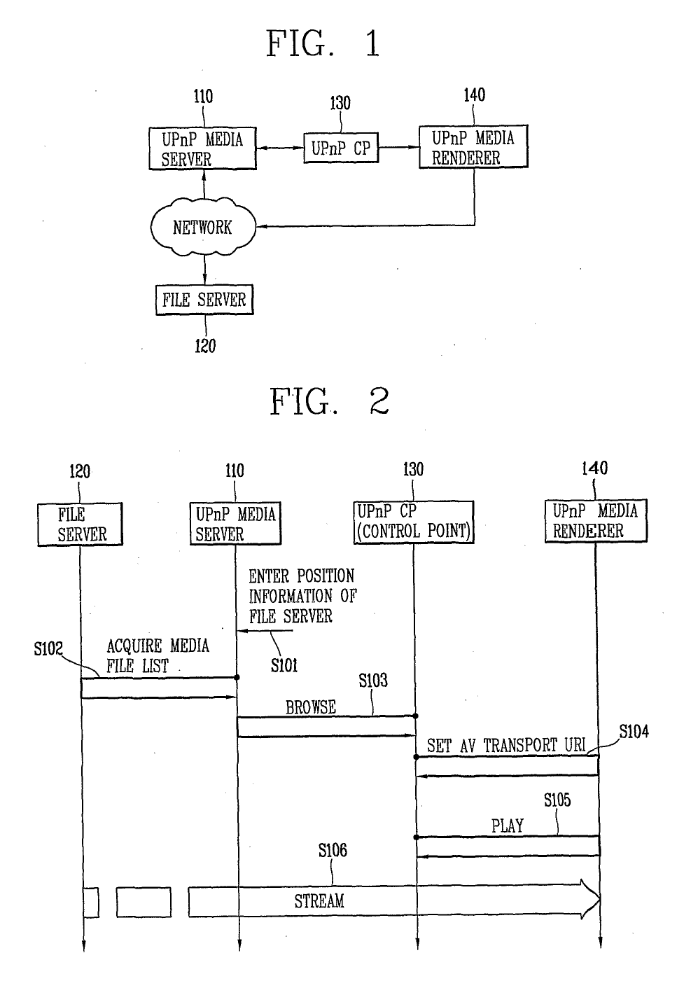

Hereinafter, a preferred embodiment of a media file playback system and method which are able to easily playback media files in a file server, which does not provide a UPnP CDS (Content Directory Service), through a UPnP media renderer connected to a UPNP-based network will be described in detail with reference to FIGS. 1 and 2.

FIG. 1 is a block diagram showing a media file playback system in accordance with the present invention.

As shown in FIG. 1, the media file reproducing (playback) system of the present invention comprises: a file server 120 providing a FTP service (file transfer protocol service) and/or a distributed file service so as to transmit first media files via a network; a UPnP media server 110 being connected to the above network and a UPnP-based network, providing a UPnP CDS (content directory service) for transmitting a list of second media files and the information on the second media files and acquiring a first media file list having the address information of the first media files; a UPnP control point 130 being connected to the UPnP-based network, acquiring the first media file list from the media server 110 by requesting the media server 110 for the first media file list, displaying the first media file list on a user interface (e.g., a display screen) and providing the address of a media file selected by a user from the first media file list; and a UPnP media renderer 140 being connected to the network and the UPnP-based network, downloading the media file corresponding to the above media file address directly from the file sever 120 and playing back the downloaded media file.

The UPnP media server 110 connected to the UPnP-based network is a UPnP device storing and providing media files, such as music, moving images, pictures, etc., which basically has a CDS (content directory service) providing a list of media files and the information on the media files.

The UPnP media sever 110 has the function of providing the files (e.g., media files, a media file list), that are held by the file server 120 (e.g., a FTP server and/or a distributed file server) connected to a common network except for the UPnP-based network, to the UPnP media renderer 140 through a UPnP protocol. Further, the UPnP media server 110 has a user interface receiving the position information of the file server 120 at a remote place connected to the common network. Here, the user interface may be embodied as a keyboard mounted to the UPnP media server 110, or an interface device for acquiring the position information of the file server 120 via the network, or a UPnP action (e.g., a vendor-specific UPnP action) designated by a manufacturer.

When the position information of the file server 120 is inputted through the user interface, the UPnP media server 110 accesses to the file server 120 based on the position information, acquires a media file list from the file server 120, and provides the address of the media file selected by the user from the medial file list to the UPnP control point 130 by the Browse action of the UPnP control point 130 capable of communication with the UPnP CDS.

The file server 120 (e.g., a FTP server and/or a distributed file server) is a server having the function of transmitting its media files via a network. Here, the FTP (file transfer protocol) is generally referred to as a file transfer standard protocol of the internet which is made for the purpose of showing a list of files (e.g., media files, document files, image files, etc.) and transmitting/receiving the files over the internet. Such a FTP includes a LIST command for getting out a directory list, a CWD command for changing a directory, a RETR command for receiving a file, etc.

Hereinafter, the operation of the media file playback system in accordance with the embodiment of the present invention will be described with reference to FIG. 2.

FIG. 2 is a signal flow chart showing a media file playback method in accordance with the embodiment of the present invention.

Firstly, when a user inputs the position information of a file server 120 located at a remote place through a user interface of a UPnP media server 110 (S101), the UPnP media server 110 accesses to the file server 120 based on the position information to acquire a media file list from the file server 120 (S102). Here, the medial file list in the file server 120 contains address information of media files and additional information on the media files.

Meanwhile, in case the file server 120 is a FTP server the UPnP media server 110 accesses to the FTP server through a FTP (file transfer protocol), finds out what directories and files exist in the FTP server using the LIST command of the FTP, and then moves to a specific directory using the CWD command of the FTP. At this time, the UPnP media server 110 can acquire a media file list of the FTP server using the LIST command again while it has moved to the specific directory.

On the contrary, in case the file server 120 is a distributed file server, the UPnP media server 110 can acquire a media file list from the distributed file server suing a distributed file service protocol.

Afterwards, when the UPnP media server 110 receives the media file list from the file server 120, the UPnP control point 130 invokes the Browse action of the UPnP CDS in the UPnP media server 110.

If the UPnP control point 130 invokes the Browse action of the UPnP CDS, the UPnP media server 110 transmits the media file list to the UPnP CP 130. At this time, the UPnP media server 110 responses to the Browse action to transmit a XML (Extensible Markup Language) <res>field (address information of medial files) designating the position of the media files in the file server 120 to the UPnP control point 130 along with the media file list, so that the UPnP media renderer 140 can download the media files in the file server. Here, in case the file server 120 is a FTP server, the <res>field is entered in the form of ‘ftp://address/file’, and in case the file server 120 is a distributed file server, the <res>field is entered in the form of ‘file://address/file’. Hence, the UPnP media renderer 140 is able to directly access to the FTP server and/or distributed file server through the <res>field (the address information of media files) transmitted to the UPnP CP 130.

Afterwards, if the user sets the playback of a media file, the UPnP CP 130 display the media file list on the user interface screen (e.g., display screen) so that the user can select a desired media file in the media file list.

If the user selects a given media file from the media files displayed on the user interface screen, the UPnP control point 130 invokes a Set AV Transport URI(Audio/Video Transport uniformed resource identifier) of the AVT service (Audio/Video Transport service) of the UPnP media renderer 140 to play back the selected media file, provides the URI (the address information of the selected media file) to the UPnP media renderer 140 based on the transmitted media file list, and then invokes a Playback action (S104 and S105).

Afterwards, the UPnP media renderer 140 directly accesses to the file server 120 based on the URI (the address information of the selected media file) provided from the UPnP control point 130, and downloads the selected media file (the streams of the media file) from the file server 120. Further, the UPnP media renderer 140 plays back the downloaded media file under control of the UPnP control point 130 (S106).

Although the embodiment of the present invention has suggested a FTP server and a distributed file server as a file server, the present invention also may be applicable to devices utilizing protocols, such as Gopher, Http, etc., provided via a network, which is enabled by entering a corresponding Uniform Resource Identifier (URI; address information of files) in the <res>field.

Furthermore, the present invention is not limited to a UPnP-based network but is able to provide media files to the user via various networks, thereby satisfying a variety of preferences of the user.

As described above in detail, the media file playback system and method of the present invention is able to easily play back media files in a FTP server or distributed file server through a media renderer connected to a UPnP-based network.

1. A media file playback method, comprising the steps of:
receiving position information of a file server providing a FTP (file transfer protocol) service and/or a distributed file service through a media server connected to a UPnP(Universal Plug and Play)-based network; and
playing back a medial file in the file server through a media renderer connected to the UPnP-based network based on the position information.

2. A media file playback method, comprising the steps of:
receiving position information of a file server providing a FTP (file transfer protocol) service and/or a distributed file service through a media server connected to a UPnP(Universal Plug and Play)-based network;
downloading a media file in the file server by accessing to the file server based on the position information; and
playing back the downloaded media file through a media renderer connected to the UPnP-based network.

3. The method of claim 2, wherein the step of downloading a media file in the file server comprises the steps of:
acquiring a media file list in the file server by accessing the file server based on the position information;
receiving the address of a medial file selected by a user from the acquired media file list; and
downloading the media file corresponding to the address of the media file selected by the user from the file server.

4. A media file playback method, comprising the steps of:
receiving position information of a FTP (file transfer protocol) server or a distributed file server through a media server providing media contents via a UPNP-based network;
acquiring a media file list in the file server based on the position information;
providing the acquired media file list to a control point connected to the UPnP-based network through the media server;
providing the address information of a media file selected by a user from the acquired media file list to a media renderer connected to the UPNP-based network under control of the control point;
downloading the media file corresponding to the address information of the medial file selected by the user directly from the file server through the media renderer; and
playing back the downloaded media file through the media renderer.

5. The method of claim 4, wherein the step of providing the address information of a media file is the step of providing the address information of a media file to the media renderer through the media server when a CDS (content directory service) action in the media server is invoked.

6. The method of claim 4, wherein the step of providing the media file list to a control point connected to the UPnP-based network further comprises the step of:
displaying the media file list on a user interface screen under control of the control point.

7. A media file playback system, comprising:
a file server being connected to a network and providing a media file;
a media server being connected to the network and the UPnP-based network and receiving a media file list in the file server via the network based on the position information of the-file server;
a media renderer being connected to the network and the UPnP-based network and playing back the media file corresponding to at least one media file address registered in the media file list of the file server.

8. The system of claim 7, wherein the file server is a FTP (file transfer protocol) server or a distributed file server.

9. The system of claim 7, wherein the media renderer is controlled by the control point connected to the UPnP-based network, downloads the media file corresponding to the above address from the file server and plays back the downloaded media file.

10. The system of claim 7, further comprising:
a control point being connected to the UPnP-based network and displaying the media file list on a user interface screen.

11. The system of claim 7, wherein the media server further comprises a user interface for being provided with the position information of the file server.

12. The system of claim 11, wherein the user interface is a keyboard mounted to the media server or an interface device for acquiring the position information of the file.

13. The system of claim 11, wherein the user interface is a UPnP action.

14. A media file playback system, comprising:
a file server providing a FTP(file transfer protocol) service and/or a distributed file service so as to transmit first medial files via a network;
a UPnP media server being to the above network and a UPnP-based network, providing a CDS (content directory service) transmitting the information of second medial files and acquiring a first media file list having the address information of the first media files;
a UPnP control point being connected to the UPnP-based network, acquiring the first media file list from the media server by requesting the media server for a the first media file list and providing the address of a medial file selected by a user from the acquired first media file list; and
a UPnP media renderer being connected to the UPnP-based network, downloading the media file corresponding to the above media file address directly from the file server and playing back the downloaded media file.

15. The system of claim 14, wherein the UPnP control point displays the first media file list on a user interface screen.

16. The system of claim 14, wherein the media server further comprises a user interface for being provided with the position information of the file server.

17. The system of claim 16, wherein the user interface is a keyboard mounted to the media server or an interface device for acquiring the position information of the file.

18. The system of claim 16, wherein the user interface is a UPnP action.

19. A media file playback system, comprising:
a FTP (file transfer protocol) server; and
a media renderer being connected to a UPnP-based network, downloading a medial file provided from the FTP server based on the position information of the FTP server and playing back the downloaded media file.

20. A media file playback system, comprising:
a distributed file server; and
a media renderer being connected to a UPnP-based network, downloading a medial file provided from the distributed file server based on the position information of the distributed file server and playing back the downloaded media file.
